(19) United States
(12) Patent Application Publication
(10) Pub. No.: US 2001/0033503 A1
(43) Pub. Date: Oct. 25, 2001

(54) Low power lighting system with LED illumination

(76) Inventors: Charles Henry Hamp, Broomfield, CO (US); David James Mitchell, Highlands Ranch, CO (US)

Correspondence Address: Charles Hamp, 13333 Briarwood Dr., Broomfield, CO, 80020, US

(21) Appl. No.: 09/803,580

(22) Filed: Mar. 9, 2001

Related U.S. Application Data
(60) Provisional application No. 60/192,432, filed on Mar. 28, 2000.

(51) Int. Cl. H02M 7/00

(52) U.S. Cl. 363/73

(57) ABSTRACT

A DC-DC converter is configured as a constant current source to drive an LED load. This circuit configuration draws constant power from the input supply and delivers a constant current to the light source. A wide range of output voltages can be supported due to the implementation of current feedback for closed loop control. This allows for a selectable number of LED's to be powered simultaneously in a series configuration. Exceptional battery life is achieved due to the constant power discharge mode achieved with constant current feedback control. LED's powered at a constant current maintain a constant brightness level throughout the life of the battery.

### BACKGROUND OF THE INVENTION

An LED is a current driven device that provides a given amount of light output for a given current. The present method for driving an LED is to provide a power source that is of significantly higher voltage than the forward voltage required by the LED and then placing a resistor in series between power source and LED to provide a current source to drive the LED. For example, consider a 6 V source used in conjunction with an LED that has forward voltage of 3.0 V when driven at 10 mA. For this case a 300 ohm series resistor would be required to develop a 10 mA current source. The forward voltage drop of an LED varies from device to device and also due to temperature change. Therefore, this simple circuit does not maintain a constant current source. As the supply voltage increases in relation to the forward voltage drop of the LED the stability of the constant current source improves. But this comes at the expense of wasted power. In a battery-powered system the batteries must be stacked in series to provide adequate voltage to support the forward voltage of the LED and series resistor. Typically four, 1.5 VDC batteries are used to provide a 6 V source. But battery output voltage decays as energy is drawn from it. The output range is approximately 1.5 VDC at initial discharge to 0.8 VDC at end of life. Therefore, the current source provided by the series resistor would have a wide current variation due to battery voltage decay. Poor regulation of the current source means excessive power dissipation and excessive light variation. A linear voltage regulator is sometimes employed in series between the battery and current source resistor. This configuration maintains a constant voltage to the series resistor/LED, which minimizes current variation at the expense of more power dissipation.

### SUMMARY OF THE INVENTION

The invention relates to a constant current drive method to provide a constant light source using Light Emitting Diodes (LEDs). DC-DC conversion is utilized to efficiently convert an input voltage to a different output voltage. Expected efficiency is 65% to 75%. The output voltage level is determined based on the voltage necessary to bias an LED or multiple LEDs in series at a constant current level LED light output is directly proportional to current and thus light output remains constant. A DC-DC converter configured as a constant current source will adjust the output voltage to maintain constant current. Therefore the series LED configuration can be increased or decreased and the DC-DC converter output voltage will automaticly adjust to maintain constant current. When used in conjunction with a battery source the LED light source will maintain constant light brightness until end of battery life. An efficient, rugged and reliable lighting system that does not require bulb replacement is achieved with this design.

### DESCRIPTION OF DRAWINGS

FIG. 1 is a configuration of a DC-DC boost converter for driving series LED's at a constant current level. An oscillator is shown for strobe capability.

FIG. 2 is a proposed schematic for packaging into a flashlight design.

FIG. 3 is a proposed volume for the schematic shown in FIG. 2.

FIG. 4 is a Printed Wiring Assembly (PWA) for the schematic and volume shown in FIGS. 2 and 3 respectively.

### DETAILED DESCRIPTION OF THE INVENTION

A boost regulator circuit driven from 2 series 1.5 VDC batteries is shown in FIG. 1. It is configured as a constant current source to drive a series LED load. The circuit consists of eight sections. These are the input filter 1, Pulse Width Modulator (PWM) 2, switching inductor 3, output rectification 4, feedback 5, battery supply 6, on/off switch 7 and a series LED stack with shorting switches 8. The input filter consists of C1. It provides a low impedance input AC source to the PWM (U1). In this configuration the capacitor (C1) provides the high switching currents required by the power switch located in U1 and the battery provides a more constant current flow to recharge the capacitor while also providing some dynamic current to the switch. The low impedance provided by the capacitor (C1) also aids system stability. The driver stage consists of the inductor (L1) and the switch internal to the PWM at U1-1. The output stage consists of CR1 and C2. When the switch is active a low impedance path is provided from U1-1 to ground. Thus, the battery voltage is applied across L1 and the current begins to ramp linearly upward across the inductor. At switch turn-off, inductive action causes L1 to flyback which forces L1-2 positive. L1-1 is clamped to the input supply voltage and L1-2 rises until the voltage is clamped by C2 through CR1. Current then conducts through CR1, charging C2. Current then ramps linearly downward until L1 is discharged and current flow through CR1 ceases. The switch at U1-1 then turns on, beginning a new cycle. The frequency of operation for this system is 1.4 MHz. Power from the DC-DC converter is supplied to the LED load. Output power is defined as the voltage across the series LED's multiplied by the current passed through the LED's. Each LED has a forward voltage drop of 2.8 V to 3.0 V depending on the current drive level selected. A sense resistor (R1) and op-amp (U2) provide current feedback to the PWM (U1). A voltage proportional to current is sensed at R1 and amplified by U2 to provide a feedback voltage to U1-3. The amplifier is configured with a gain of 12 such that the input to output transfer function is:

(1) V(U1-3)=12*R1*I(LED)

The voltage required at U1-3 is 1.25 V. Thus R1 is selected to control the current level through the LED's. The configuration shown sets the LED current at approximately 10 mA. The feedback signal is compared to the 1.25 V internal reference of U1. The error between the internal reference and the feedback voltage determine the conduction time for charging L1 where duty cycle is defined as:

(2) T(Conduction)/T(Period)

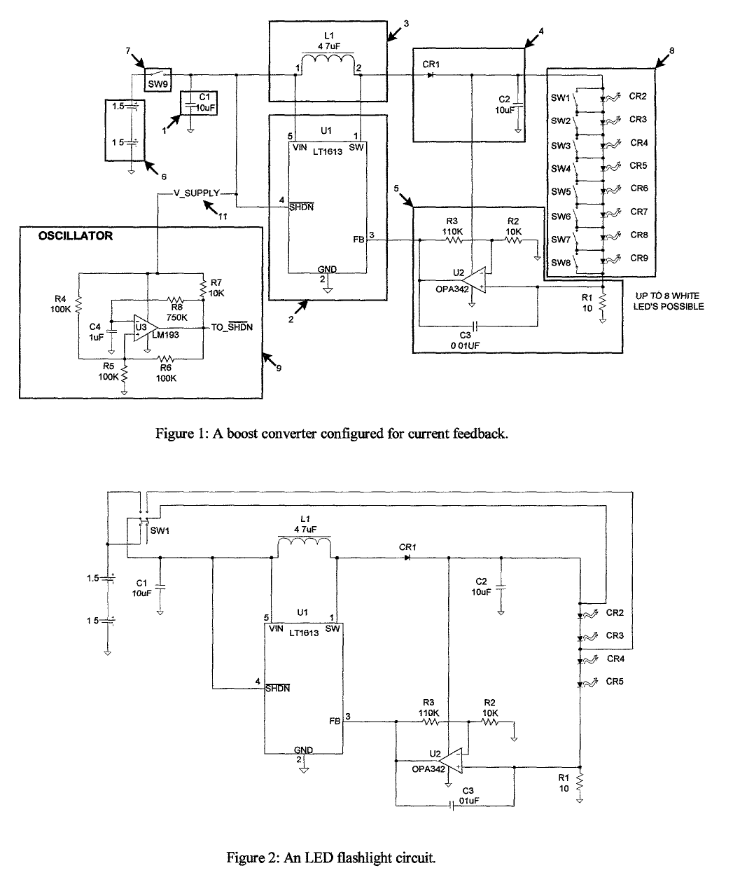

Longer conduction times indicate higher power transfer to the output. A feedback signal that is low with respect to the internal reference voltage will cause an increase in duty cycle while a high feedback voltage will produce a reduced duty cycle. Therefore a constant current level at the output is maintained. Two series batteries are used for the power source. Any supply voltage above the minimum required by the DC-DC converter but below the forward drop of the LED stack is acceptable. DC-DC conversion with current feedback is still valid even if the source voltage is greater than the required output voltage. But the DC-DC voltage conversion method must be modified from the boost topology shown in FIGS. 1 and 2 to a buck converter or other method. In general, any DC-DC conversion topology can be combined with a LED current sensing methodology to provide an efficient constant brightness light source. A switch, SW9, is incorporated for on/off control. The series LED/switch section (CR2-CR9, SW1-SW8) provides an adjustable light output configuration. This configuration allows the user to select from one to eight energized LED's. All of which will maintain a constant light output through end of battery life.

Two 1.5 VDC batteries placed in series was selected to maximize energy draw from the battery supply. Additional batteries can be added in parallel to increase light duration. Battery end of life is considered to be 0.8 V. This produces an end of life output of 1.6 V (two batteries in series) at the PWM (U1) input. U1 has an operational range down to 0.9 V. Therefore complete energy drain from the battery supply will occur, all the while providing a constant light output.

The PWM (U1) used for DC-DC conversion was selected for high switching speed, high efficiency at low load, low operating voltage and boost topology. A switching speed of 1.4 MHz allows for the use of small inductors and output capacitors. This reduces both cost and physical size of these passive devices. A boost topology provides a means of converting a lower input voltage (battery supply) to a higher output voltage. This allows for an adjustable output configuration of up to 8 LED's (30 V Max) in series. The boost converter draws constant power from the battery supply when driving the constant load of the LED's. Of the three battery discharge modes, constant resistance, constant current and constant power, constant power mode is the superior method for maximum usable energy from a battery source. Conversion efficiencies of 65-75% can be achieved at current levels of 10-20 mA respectively while operating from a supply as low as 0.9 V.

With the incorporation of an oscillator 9 this circuit can be configured to provide strobe light capability. The additional circuitry is shown at left in FIG. 1. Power for this circuit is derived from the battery supply (V_SUPPLY) 11. The oscillator circuit design has minimal impact on cost and overall size.

A rugged, highly reliable lighting system that does not require bulb replacement is achieved with this design. Reliability is enhanced through a number of ways. A highly integrated PWM reduces part count. This, coupled with surface mount componentry provides for a highly compact design. The Printed Wiring Board (PWB) required is small. The assembly will be very rigid due to the small size and the mechanical resonant frequency will be extremely high. Therefore the package will be highly resistant to solder fatigue due to vibration and shock. Issues due to mismatched Thermal Coefficients of Expansion (TCE) between the PWB and componentry is minimized due to small part size and relatively large solder joints. Therefore the circuit will be limited in temperature range by battery performance rather than circuit design. It is expected that the lifetime of the drive circuitry will be compatible with the 100,000-hour lifetime of the LED light source.

The overall concept presented above consists of a DC-DC conversion method coupled with a feedback method that maintains constant current through the LED's. This provides a light source with constant brightness independent of input voltage variation. An efficient means of drawing power from the power supply is achieved due to the constant power draw required by the load.

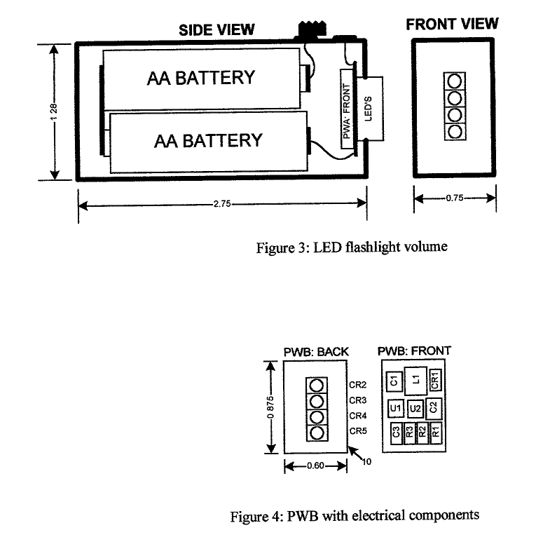

The compact design allows for a package that is lightweight, rugged and functional. A possible circuit configuration is shown in FIG. 2. This configuration provides two light settings of two or four energized LED's plus an off position. The overall package for this circuit configuration can be housed in a volume of 2.64 in³ as shown in FIG. 3. The Printed Wiring Board (PWB) 10 would house the circuitry on one side and the LED's on the outside. The PWB outline with componentry is shown in FIG. 4. All circuitry, including LED's can be mounted on the two-sided PWB, thereby reducing assembly costs.

This circuit provides an energy efficient method of discharging the battery supply while supplying a constant current to the load. Constant current mode of operation produces a constant light output through out the life of the batteries. In addition, it allows for an adjustable number of LED's in series. All the while maintaining constant light output from each LED. This permits the user to adjust the number of LED's energized versus battery life to suit the appropriate situation.

1. A power conserving device, comprising:
a constant current circuit configured to generate a constant load current based on an input voltage from a power source and a feedback voltage;
a load device coupled to the constant current circuit and configured to drop a load voltage based on the constant load current; and
a feedback circuit coupled to the load device and the constant current circuit and configured to determine the feedback voltage based on constant load current

2. The power conserving device of claim 1 further comprising a battery as the power source.

3. A flashlight, comprising:
a constant current circuit configured to generate a constant load current based on an input voltage from a power source and a feedback voltage;
a light source coupled to the constant current circuit and configured to emit light generated from the constant load current; and
a feedback circuit coupled to the constant current circuit and the light source and configured to determine the feedback voltage based on the constant load current.

4. The flashlight of claim 3 wherein the light source comprises a Light Emitting Diode.

5. The flashlight of claim 3 wherein the light source comprises a plurality of Light Emitting Diodes.

6. The flashlight of claim 3 wherein the light source comprises a plurality of white Light Emitting Diodes.

7. The flashlight of claim 3 wherein the light source comprises an array of Light Emitting Diodes arranged to emit the light substantially along a common axis.

8. A method of generating a light beam in a flashlight, the method comprising:
applying an input voltage to a constant current circuit;
applying feedback voltage to the constant current circuit;
generating a constant load current in the constant current circuit based on the input voltage and the feedback voltage;
supplying the constant load current to a light source wherein the light source emits light generated from the constant load current; and
determining the feedback voltage in a feedback circuit based on the constant load current.

9. The method of claim 8 wherein the step of supplying the constant load current comprises supplying the constant load current to an array of Light Emitting Diodes.

10. The flashlight of claim 3 wherein the light source enable is driven by an oscillator means to provide a strobe light.

11. The flashlight in claim 3 wherein power is intermittently supplied to the light source to provide a strobe light.
